(19) United States
(12) Patent Application Publication
(10) Pub. No.: US 2008/0261473 A1
(43) Pub. Date: Oct. 23, 2008

(54) Polysiloxane and textile auxilary containing a polysiloxane

(76) Inventors: Peter Will, Gomaringen (DE); Friedhelm Nickel, Tuebingen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/079,955

(22) Filed: Mar. 28, 2008

(30) Foreign Application Priority Data
Mar. 28, 2007 (DE) 10 2007 015 372.6

(51) Int. Cl. D03D 15/00; C08G 77/04; D06M 13/513

(52) U.S. Cl. 442/181; 528/10; 252/8.63

(57) ABSTRACT

The present invention relates to a polysiloxane with the general formula (I)

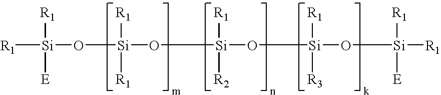

with at least one epoxy radical of an epoxydic radical and a polyether radical as well as at least one quaternary nitrogen atom as well as a textile auxiliary which contains at least one polysiloxane according to the invention.

### BACKGROUND OF THE INVENTION

The present invention relates to a polysiloxane according to the generic part of patent claim 1 and also to a textile auxiliary having a polysiloxane.

EP 1 000 959 A2 describes polyether quat functional polysiloxanes which are used in compositions for improving the surface properties of fabrics and fibres. This class of substances consists of polysiloxanes in which the Si atoms bear at least one polyether radical and at least one radical having a quaternary nitrogen atom, the counter-ion being an anion of an organic or inorganic acid. Compounds of this type are useful as textile auxiliaries for substrates composed, for example, of cotton, polyester or else leather that endow the material with a good softness and a lower tendency to yellow. What is particularly desired here but has so far only been achieved to an unsatisfactory extent is good permanence, i.e. retention on the fibre and good handlability, i.e., a viscosity which is not too high.

To solve this problem, a polysiloxane appropriate for the type and a textile auxiliary containing a polysiloxane appropriate for the type are described in DE 102 14 982 A1. The polysiloxanes appropriate for the type exhibit, apart from at least one quaternary nitrogen atom, at least one epoxy radical. By means of the epoxy radical, the polysiloxane appropriate for the type can be crosslinked on the fibre. In this way, an improved permanence, i.e. the substance can no longer be washed off from the fibre, as well as an excellent softness and particularly agreeable physiological wear comfort are obtained. The polysiloxanes appropriate for the type are suitable for all natural and synthetic fibres which are capable of reacting with epoxides, i.e. which exhibit OH radicals and/or NH radicals, for example. The side chains of the radicals are R₂ and R₃ provide a certain steric hindrance which causes the viscosity of the compounds according to the invention to be reduced such that the handlability is improved.

In practice, it has been found that the polysiloxanes appropriate for the type exhibit incompatibilities vis-a-vis polyanions and anionic auxiliaries. Such polyanions and anionic auxiliaries are contained e.g. in dyes containing optical brighteners. If the polysiloxanes appropriate for the type are applied onto a woven fabric and/or a fibre, it is possible for such polyanions and anionic auxiliaries to be entrained into the liquor. In this case, cation-anion complexes may form which are precipitated out and deposit on the woven fabric and/or the fibre. These precipitates may be solid or oily, colourless or coloured.

### SUMMARY OF THE INVENTION

The object of the present invention consists in developing the polysiloxanes appropriate for the type further to such an extent that the compatibility with anions, in particular polyanions and anionic auxiliaries, is improved.

This object is achieved by polysiloxanes with the features of claim 1 and textile auxiliaries with the features of patent claim 6. The present invention accordingly provides that a polyether radical is provided between the Si—O backbone of the polysiloxane and at least one epoxy radical. This polyether radical operates as hydrophilic spacer between the backbone and the epoxy radical. It has the effect that the cation-anion complexes, which may form, are no longer precipitated but dispersed in the liquor. In addition, it has surprisingly enough been found that the materials thus finished have an even better softness than previously.

Finally, a fibre or woven fabric which has been finished or treated with such a textile auxiliary is also a subject matter of the present invention.

Advantageous refinements will be apparent from the subsidiary claims. In particular, the values a, b, c may be between 0 and 15, 0 and 5 and/or 0 and 8 respectively.

The fraction of alkyl radicals having 2 to 30 C atoms can be more than 10 mole when measured against the total number of radicals.

### DETAILED DESCRIPTION OF THE INVENTION

The polysiloxanes of the present invention are preferably used in the form of aqueous emulsions. A suitable process for preparing finely divided polyorganosiloxane emulsions is, for example, known from U.S. Pat. No. 5,302,657. There, the emulsion is prepared with a polyorganosiloxane-soluble emulsifier in two steps, the first step providing a concentrate which is diluted with water in the second step. The emulsifiers used may be any emulsifiers which are usable for preparing organofunctional polysiloxane emulsions.

Useful nonionic emulsifiers are in particular alkyl polyglycol ethers, preferably those having 4 to 40 ethylene oxide units and/or alkyl radicals of 8 to 20 C atoms; alkylaryl polyglycol ethers, preferably those having 4 to 40 ethylene oxide units and/or 8 to 20 C atoms in the alkyl radicals; ethylene oxide-propylene oxide block copolymers, preferably those having 4 to 40 ethylene oxide and/or propylene oxide units; saturated and unsaturated fatty acids having 6 to 24 C atoms; natural materials and their derivatives such as lecithin, lanolin, saponins, cellulose; cellulose alkyl ethers and carboxyalkyl celluloses whose alkyl groups each possess up to 4 C atoms; linear polydiorganosiloxanes containing polar groups, especially polyether groups; saturated and unsaturated alkoxylated fatty amines having 8 to 24 carbon atoms.

Useful cationic emulsifiers are, for example, salts of primary, secondary and tertiary fatty amines having 8 to 24 C atoms, especially with acetic acid, hydrochloric acid and phosphoric acids; quaternary alkylbenzene ammonium salts, especially those whose alkyl group possesses 6 to 24 C atoms, especially the halides, sulphates, phosphates and acetates; alkylpyridinium, alkylimidazolium and alkoxyoxazolinium salts, especially those whose alkyl chain possesses up to 18 C atoms, specifically the halides, sulphates, phosphates and acetates.

Further useful emulsifiers can be selected from the group consisting of fatty acid polyglycol esters, polyethoxylated fatty acid glycerides and sorbitan esters, alkyl polyglycosides, fatty acid alkylolamides, alkyl ether carboxylic acids, alkylaryl ether carboxylic acids, ethoxylated quaternary ammonium salts, amine oxides, betaines, sulphobetaines and sulphosuccinates.

The aqueous emulsion may contain one or more inorganic and/or organic acids and/or anhydrides as a further component. Suitable are, for example, hydrochloric acid, sulphuric acid and phosphoric acid but also formic acid, acetic acid, glycolic acid, aldonic acids such as, for example, gluconic acid, ascorbic acid or uronic acids such as, for example, glucuronic acid. Oxalic acid, citric acid or aldaric acids such as glucaric or mucic acid, for example, can be used as useful polybasic acids. As an example of an anhydride of an organic acid, acetic anhydride can be mentioned.

The aqueous emulsion may further contain, as a further component, a hydrotrope which may be selected, for example, from the group of the polyfunctional alcohols. It is thus possible to use dialcohols having 2 to 10, preferably 2 to 6, but especially 2 to 4 carbon atoms per molecule. Also highly suitable are their mono- and diethers and also the mono- and diesters of these dialcohols. Substances which are to be used with particular preference are, for example, 1,2-propylene glycol, dipropylene glycol and butyl diglycol.

The preparations of the polysiloxanes of the present invention may also be combined with conventional finishing agents to achieve further textile engineering effects. Suitable components here are polyethylene compounds, fatty acid condensation products and also other organosiloxanes.

A preferred composition contains 2% to 80% by weight of at least one polysiloxane of the present invention, 0% to 40% by weight of at least one emulsifier, 0% to 5% by weight of at least one inorganic and/or organic acid and/or of an acid anhydride, 0% to 40% by weight of at least one customary finishing agent, 0% to 20% by weight of at least one hydrotrope and also 0% to 98% by weight of water.

The practical examples which follow illustrate the present invention.

### 1. Preparation of the Polysiloxanes of the Present Invention

Regarding the chemistry of polysiloxanes, in particular regarding hydrosylilation, we refer the reader to Walter Noll, Chemie und Technologie der Silikone (Chemistry and technology of silicones), Verlag Chemie Weinheim, 2nd revised edition 1968, ISBN: 0125207506 and to Bogdan Marciniec (editor), Comprehensive Handbook of Hydrosylilation, pp. 11-18, Pergamon Press 1992. Regarding quarternisation, we refer the reader to EP 1 000 959 A1. Further details can be found in DE 102 14 982 A1. The compounds according to the invention will be referred to in the following as quat compounds.

### a) Synthesis of Allyl Polyether Glycide Ethers

Commercially available allyl polyethers (obtainable e.g. from Clariant) with different compositions are reacted with epichlorohydrin in the known way (compare DE 40 03 621 A1 in this respect).

A four-neck flask equipped with stirrer, dropping funnel, thermometer and reflux condenser is charged with 1 mole of allyl polyether and heated to 80° C. Following the addition of 0.2% by weight of tin(IV) chloride, 1.5 mole of epichlorohydrin are metered in. Subsequently, 0.2% by weight of tin(IV)chloride are added two further times at an interval of 30 minutes. The additional reaction time at 80° C. amounts to 2 hours. After subsequent cooling to room temperature, 1.2 mole of sodium methylate (based on allyl polyether) are metered in as 30% solution in methanol and stirring is carried out for a further two hours. After neutralisation with dilute hydrochloric acid, the volatile components are separated off under vacuum at 100° C. Following filtration, the epoxy value is measured and the conversion determined by comparison with the theoretical value.

Table 1 summarises the allyl polyethers used and the conversion achieved for the allyl polyether glycide ethers produced therefrom.

TABLE 1

| | | | Allyl polyether glycide | |
|---|---|---|---|---|
| | Allyl polyether | | ethers | |
| | | Iodine | Epoxy value | Conversion |
| Number | EO/PO/BuO | number | [%] | [%] |
| 1 | 8/0/0 | 60 | 3.4 | 97 |
| 2 | 8/0/0 | 60 | 3.4 | 96 |
| 3 | 6/4/0 | 50 | 2.6 | 90 |
| 4 | 6/4/0 | 50 | 2.6 | 91 |
| 5 | 15/5/0 | 25 | 1.6 | 87 |
| 6 | 15/5/0 | 25 | 1.6 | 89 |
| 7 | 0/0/8 | 40 | 2.4 | 86 |
| 8 | 0/0/8 | 40 | 2.4 | 86 |

### b) Production of the Polyether Glycide Ether Siloxanes

The allyl polyether glycide ether obtained according to a) is reacted with hydrogen siloxanes in the known way (compare EP 1 448 648 A1 in this respect).

A four-neck flask equipped with stirrer, dropping funnel, thermometer and reflux condenser is charged under nitrogen with 0.1 mole of hydrogen siloxane and heated to 60° C. Following the addition of 10 ppm of a platinum catalyst, 0.13 mole of the allyl compound are metered in slowly. Subsequently, stirring is carried out at 100° C. until the hydrogen value of the siloxane is no longer measurable.

In Tables 2 and 3, the hydrogen siloxanes used and the reaction products are summarised together with the various allyl polyether glycide ethers.

TABLE 2

Hydrogen siloxane

| | | | | Hydrogen value |
|---|---|---|---|---|
| Number | D | D′ | M′ | [%] |
| A | 80 | 2 | 2 | 0.06 |
| B | 25 | 2 | 2 | 0.17 |

TABLE 3

| Number | Number | Number | |
|---|---|---|---|
| Allyl polyether | Hydrogen | Polyether glycide | Epoxy |
| glycide ether | siloxane | ether siloxane | value |
| 1 | A | 1A | 0.86 |
| 2 | B | 2B | 2.58 |
| 3 | A | 3A | 0.76 |
| 4 | B | 4B | 2.43 |
| 5 | A | 5A | 0.41 |
| 6 | B | 6B | 1.31 |
| 7 | A | 7A | 0.72 |
| 8 | B | 8B | 2.28 |

### c) Production of the Quat Compounds According to the Invention

A four-neck flask equipped with stirrer, dropping funnel, thermometer and reflux condenser is charged with the epoxy-functional siloxane and heated to 80° C. At this temperature, a mixture of 0.1 mole of acetic acid and 0.1 mole of a tertiary amine, based on 0.2 mole of the epoxy groups of the siloxane, is metered in. The additional reaction time is 3 hours. The product is obtained as a viscous, clear, yellow oil.

### II. Technical Assessment

The quaternary polysiloxanes obtained according to I.c) (quat compounds) are converted to emulsions by processes known as such (compare e.g. U.S. Pat. No. 5,302,657 in this respect).

Table 4 summarises once more the quaternary polysiloxanes used. The comparative example corresponds to Example no. 3 (80/2/2-quat) in line with DE 102 14 982 A1.

TABLE 4

| Example | Polysiloxane |
|---|---|
| C | quat from 1A |
| D | quat from 2B |
| E | quat from 5A |
| F | quat from 6B |
| G | quat from the |
| | comparative |
| | example |

The anion stability of the quaternary polysiloxanes is verified by way of the compatibility with a highly affinic optical brightener. For this purpose, the emulsions of examples B to G were used to prepare liquors with 100 g/l and mixed with a solution of 30 g/l of an optical brightener (e.g. TUBOBLANC HV) in a ratio of 1:1. The mixture was then stored for 1 h at 40° C. The appearance of the liquor was first assessed at room temperature and then after storage at 40° C. The results are summarised in Table 5.

TABLE 5

| Example | Room temperature | After 1 h at 40° C. |
|---|---|---|
| C | Clear | Slightly opaque |
| D | Clear | Clear |
| E | Clear | Slightly opaque |
| F | Clear | Clear |
| G | Turbid | Precipitations |

What is claimed is:

1. Polysiloxane of the general formula (I) 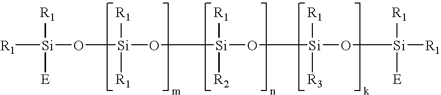
where m is an integer from 5-200,
n is an integer from 0-25,
k is an integer from 1-25,
R₁ is an aliphatic C₁ to C₃₀ radical or a phenyl radical,
R₂ is an aliphatic C₉ to C₃₀ radical and/or a polyether radical of the general formula (CH₂)₃O(C₂H₄O)ₓ(C₃H₆O)_{y}Q where x and y may be the same or different and represent an integer between 0 and 50 and Q is hydrogen or an alkyl radical of 1 to 4 C atoms,
R₃ is an epoxy radical or an MZ radical,
E is an MZ radical, R₃ or R₂,
each molecule containing at least one epoxy radical —PY and one MZ radical,
the epoxy radical —PY exhibiting an acidic radical Y which is selected from the group comprising 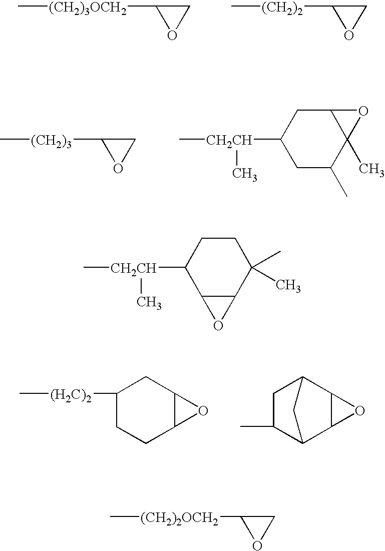
the epoxy radical —PY representing a polyether radical P with the general formula (CH₂)₃O(C₂H₄O)ₓ(C₃H₆O)_{y}, a, b and c being identical or different, M being selected from the group comprising 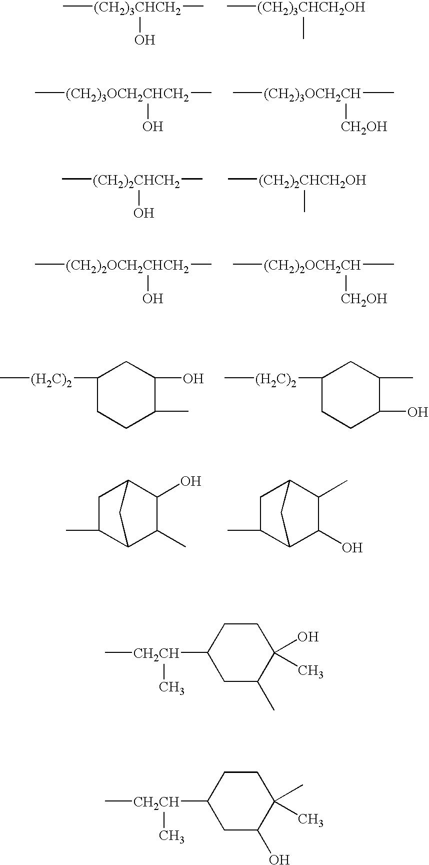
Z being selected from the group comprising 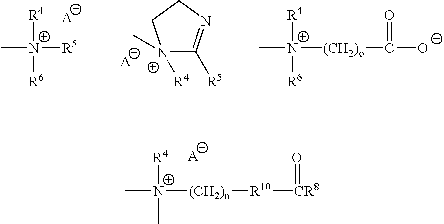
where the quaternary nitrogen atom of the Z radical is attached to the M radical via the carbon atom adjacent to the C—OH group in the M radical,
R⁴, R⁵ and R⁶ may be the same or different and may represent H, C₁ to C₂₂ alkyl, C₁ to C₂₂ alkenyl, which alkyl or alkylene radicals may contain hydroxyl groups,
R⁸ and R⁹ may be the same or different and each has the same meaning as R⁴, R⁵ and R⁶ or are fluorine-, chlorine- or bromine-substituted C₁ to C₁₀ alkyl radicals,
R¹⁰ represents —O— or an NR¹¹ radical where R¹¹=H, C₁ to C₄ alkyl or C₁ to C₄ hydroxyalkyl,
o represents an integer from 1 to 4, and
A^{Θ} represents an organic or inorganic anion derived from a customary physiologically tolerable acid HX.

2. Polysiloxane according to claim 1 characterised in that a represents an integer between 0 and 15, b represents an integer between 0 and 5 and c represents an integer between 0 and 8.

3. Polysiloxane according to claim 1 characterised in that the fraction of C₂ to C₃₀ alkyl radicals is more than 10 mol %, measured against the total number of radicals.

4. Polysiloxane according to claim 1 characterized in that R₂ is an aliphatic C₁₀ to C₂₀ radical.

5. A polysiloxane according to claim 1 characterized in that the polyether radical represents the general formula (CH₂)₃O(C₂H₄O)ₓ(C₃H₆O)_{y}Q, where x and y may be the same or different and x represents an integer between 1 and 25, y is an integer between 0 and 25 and Q is hydrogen or an alkyl radical of 1 to 4 C atoms.

6. A textile auxiliary characterized in that it contains at least one polysiloxane according to claim 1.

7. A textile auxiliary according to claim 6, characterised in that it is in the form of an aqueous emulsion.

8. A textile auxiliary according to claim 7, characterised in that it contains at least one nonionic and/or cationic emulsifier.

9. A textile auxiliary according to claim 6, characterised in that it contains one or more inorganic and/or organic acids and/or anhydrides.

10. A textile auxiliary according to claim 6, characterised in that it contains at least one hydrotrope.

11. A textile auxiliary according to claim 1, characterised in that it contains 2% to 80% by weight of at least one polysiloxane according to claim 1 to 5, 0% to 40% by weight of at least one emulsifier, 0% to 5% by weight of at least one inorganic and/or organic acid and/or of an acid anhydride, 0% to 40% by weight of at least one customary finishing agent, 0% to 20% by weight of at least one hydrotrope, and also 0% to 98% by weight of water.

12. Fibre or woven fabric characterised in that it comprises at least one polysiloxane according to one of claim 1 or has been treated with a textile auxiliary according to claim 6.
